(19) United States
(12) Patent Application Publication
(10) Pub. No.: US 2007/0289452 A1
(43) Pub. Date: Dec. 20, 2007

(54) Coffee Machine with a Continuous Flow Heater

(76) Inventors: Edwin Hofer, Bellheim (DE); Johann Magg, St. Georgen (DE); Andreas Mayr, Breitbrunn am Chiemsee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(21) Appl. No.: 10/587,225

(22) PCT Filed: Jan. 28, 2005
(86) PCT No.: PCT/EP05/50361

§ 371 Date: May 25, 2007

(51) Int. Cl. A47J 31/54

(52) U.S. Cl. 99/295

(57) ABSTRACT

A coffee machine for preparing coffee, in particular based on coffee pads. Said coffee machine comprises a continuous flow heater which is secured in a housing and which comprises a pipe which is used to guide water. A tubular connection support is disposed on at least one end of the pipe in order to secure the continuous flow heater in an economical and reliable manner and preferably, additional components in the coffee machine. Also, the tubular connection support is connected to securing means in order to secure the continuous flow heater in the housing.

The invention relates to a coffee machine.

Coffee machines in the prior art operate according to different principles. The most common models are the so-called pressureless coffee machines. In these water flows from a storage container into an electrically heatable pipe. Particularly as a result of the evolution of steam in this pipe, heated water is then pushed through a riser to an outlet via which the heated water then drips into a coffee filter. The filter coffee can then flow from this coffee filter at atmospheric pressure into a pot.

In contrast, in espresso machines an elevated pressure prevails in the area of the coffee grounds, for example 15 bar. This is achieved by supplying water from a water container or another water supply to an electric-motor-driven pump which then supplies the water at high pressure via an electrically heatable area to a coffee grounds receiving device. This coffee grounds receiving device generally comprises a filter for receiving the coffee. In order to generate the high pressure in the coffee area, during operation the coffee grounds receiving device is located in an area which is sealed towards the atmosphere, which can be designated as a pressure chamber or brewing chamber.

In another coffee machine which operates on a different principle, it is provided to first transfer the water for preparing the coffee from a water container into a heatable intermediate container. From this intermediate container the heated water is passed to an electric-motor-driven pump from which it is supplied at elevated pressure, for example 2 to 3 bar, to a coffee grounds receiving device. In this case, it is provided that unlike in the espresso machine the coffee is not introduced into the coffee grounds receiving device in loose form as coffee grounds but is inserted in a retainer in the form of a coffee pad, that is, in compacted form surrounded by filter paper. The retainer with a retainer cover via which water is supplied can form a sealed pressure chamber. At the same time, the retainer for the coffee pads is allocated a plurality of functions. Firstly, the retainer provides a sealing surface so that a pressure chamber can be formed. Moreover, the retainer has an outlet opening from which the coffee can emerge. Furthermore, the coffee pad should be mounted in the retainer in a manner such that flow through the coffee pad is not impeded. Such a coffee machine occupies an intermediate position between a conventional pressureless coffee machine and an espresso machine.

In particular in connection with coffee machines which prepare coffee on the basis of coffee pads, the water conveyed by the pump can be heated in a continuous flow heater. WO 03/030696 A1 describes such a coffee machine. The continuous flow heater comprises a tubular section which is partially enclosed by heating elements embedded in cast aluminium. This entire arrangement with further components is surrounded by a housing whereby the continuous flow heater is inserted in the coffee machine housing. Such a solution is complex and thus associated with high costs.

It is the object of the invention to provide a coffee machine with a continuous flow heater which can be manufactured simply and cost-effectively, and in particular is improved with regard to the assembly of the continuous flow heater and other components in the housing. This object is achieved with the features of the independent claims. Advantageous embodiments of the invention are given in the dependent claims.

The invention builds on the generic coffee machine in that the tubular connection support comprises securing means for securing the continuous flow heater in the housing. These tubular connection supports can be internally or externally sealing and they provide a simple possibility for fitting on a hose for supplying or removing water.

It is usefully provided that the at least one tubular connection support is made of plastic, in particular is made of high-temperature resistant plastic. A heat-resistant plastic provides good heat insulation between the continuous flow heater and the housing or the hoses. Furthermore, securing means for centring the continuous flow heater in the housing and which provide the possibility of securing the continuous flow heater, can be moulded simply on the tubular connection supports made of plastic.

It is preferable that the at least one tubular connection support comprises sealing means which abut against an inner wall of the pipe by which means the at least one tubular connection support is connected to the ends of the pipe in a sealed manner. The tubular connection supports can thus be connected to the pipe in a sealed manner without further precautions.

The sealing means is preferably formed by an O-ring seal inserted in an annular groove on the outer circumference of the tubular connection support.

For improving the sealing effect, a plurality of axially spaced O-ring seals can be provided on the tubular connection supports.

Both in the variant comprising one sealing means or one O-ring seal and also in the variant comprising a plurality of sealing means or O-ring seals, the tubular connection support can be inserted into a corresponding end of the pipe.

It is likewise advantageous that the at least one tubular connection support comprises securing means.

Furthermore, it is usefully provided in this connection that the continuous flow heater is held in the housing by the securing means. The alignment of the continuous flow heater in the housing is a critical quantity since it must avoided that the hot component is disposed too close to other housing parts or other components. Consequently, it is advantageous that the correct means for centring the continuous flow heater are provided immediately, so that any misalignment can be avoided.

It is furthermore particularly useful that the securing means has receiving elements for integrating additional components of the coffee machine. Since continuations or similar can simply be moulded onto the tubular connection supports made of plastic, the configuration of the tubular connection support is suitable for attaching further elements.

In this connection, it is particularly advantageous that a safety valve, temperature sensor and/or a reed switch as a water level sensor is provided as an additional component. A reed switch can be integrated, for example, in the upper tubular connection support of the continuous flow heater which is generally mounted vertically. A reed switch for detecting the water level is usefully integrated on the lower hose connection support.

Furthermore, the coffee machine according to the invention can usefully be constructed such that the pipe of the continuous flow heater is thermally connected to at least one, preferably two heating rods by means of at least one flat contact surface. This type of continuous flow heater can be manufactured particularly simply. For example, a flattened pipe can provide a flat contact surface and can be provided by simply pressing together a pipe area. As a result of the flattened areas, large areas are provided for heat transfer between the pipe and a flattened heating rod. Since no cast parts are required, the mass of the continuous flow heater is comparatively low.

The coffee machine according to the invention is preferably configured so that the arrangement of pipe and heating rods is held together by a sleeve. Such a sleeve is to be preferred to a complex housing for simplicity of manufacture. The sleeve can be made of heat-resistant plastic or of metal.

It is usefully provided that a temperature sensor is provided on the sleeve. Since the sleeve is preferably located at the centre of the elongated continuous flow heater to hold the components securely together, it is located on a preferred site for a temperature sensor. In this respect, is possible to arrange a temperature sensor in the area of the sleeve and mount this on the sleeve.

The invention is based on the finding that a continuous flow heater can be mounted in a particularly cost-effective and reliable manner in a coffee machine by using tubular connection supports preferably made of heat-resistant plastic which at the same time provide securing means both for the continuous flow heater on the housing and also for additional components of the coffee machine.

The invention is now explained in detail with reference to the accompanying drawings using particularly preferred embodiments. In the figures:

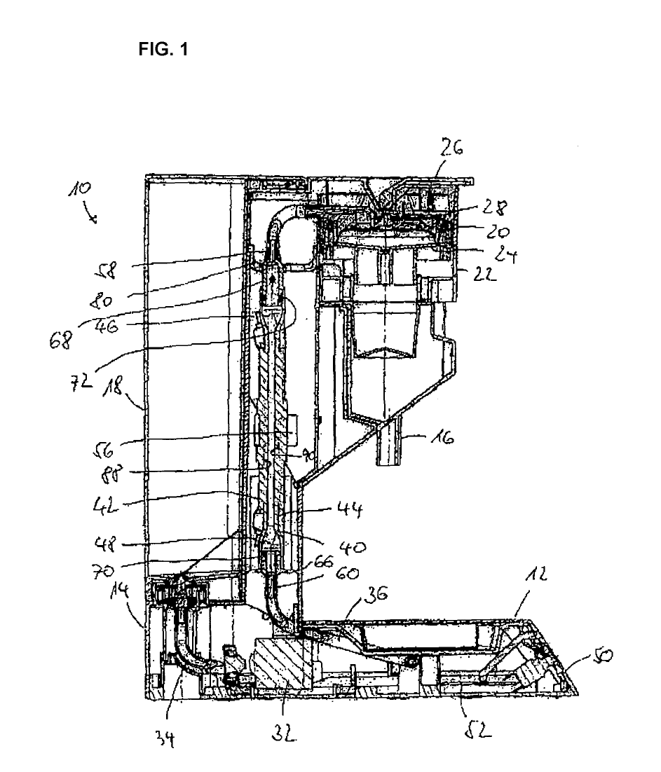

FIG. 1 is a sectional view of a coffee machine to explain the invention;

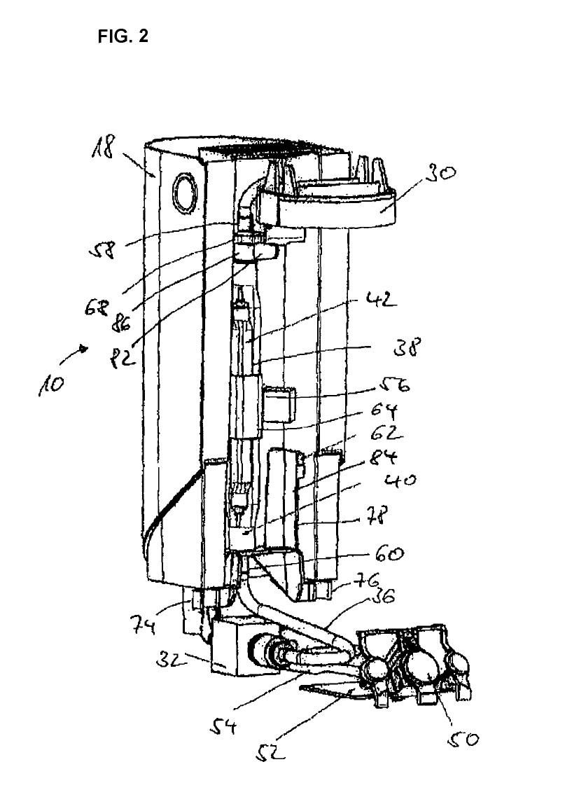

FIG. 2 is a perspective view of a housing part as well as components arranged in the housing to explain the invention; and

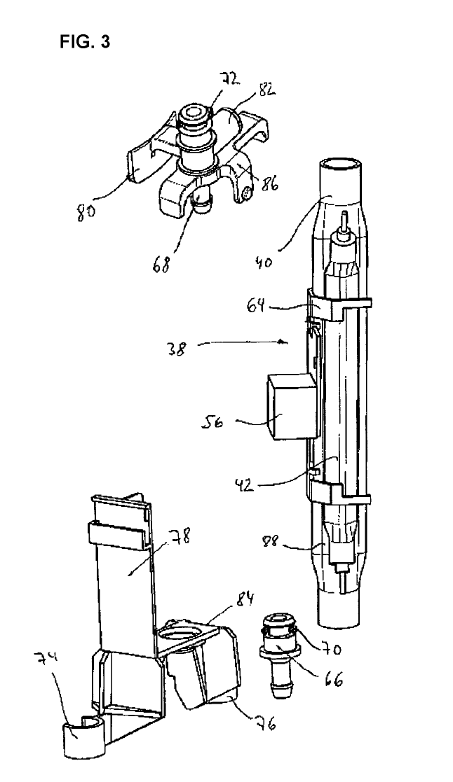

FIG. 3 is an exploded view of the continuous flow heater, tubular connection supports and receiving elements.

In the following description of the drawings the same reference numerals denote the same or comparable components.

FIG. 1 shows a sectional view of a coffee machine to explain the invention. FIG. 2 shows a perspective view of a housing part as well as components arranged in the housing to explain the invention. In FIG. 3 the continuous flow heater 38, tubular connection supports 66, 68 and receiving elements 84, 86 are shown in an exploded view. The coffee machine 10 comprises a flat front portion 12 and a columnar rear assembly 14. Cups for removing coffee via an outlet 16 can be arranged on the front portion 12. A water container 18 is inserted in the rear assembly 14. The rear assembly 14 further comprises a brewing chamber 20 formed by a coffee pad retainer 24 which can be supplied with a drawer and an elastic retainer cover 28 as the upper portion of the brewing chamber 30. A lever mechanism is provided with a lever 26 in order to seal the coffee pad retainer 24 and the retainer cover 28 with respect to one another after inserting the drawer 22. In the state shown the lever mechanism pulls the coffee pad retainer 24 towards the retainer cover 28. If the lever 26 is shifted backwards by 90°, the coffee pad retainer 24 is lowered so that it can be removed from the coffee machine 10 together with the drawer 22.

Components for supplying water, for heating water and for controlling these processes are provided inside the housing formed by the front portion 12 and the rear assembly 14. Located in the lower housing area at the boundary between the front portion 12 and the rear assembly 14 is a pump 32 to which water is supplied from the water container 18 via a hose 34. The pump 32 is connected to the continuous flow heater 38 by means of another hose 36. Important components of this continuous flow heater 38 are a pipe 40 used to carry water and two heating rods 42, 44, These heating rods 42, 44 each have two electrical connections 46, 48 to which the heating voltage is applied. Provided on the front portion 12 of the coffee machine 10 is a keypad 50 which is connected to a printed circuit board 52, said printed circuit board 52 preferably controlling all the functions of the coffee machine, especially the functions with regard to the conveyance and heating of the water. Starting from the printed circuit board 52 there is provided a cable run 54 which combines the electrical leads via which the electronic controller delivers its control commands and receives input information. This input information particularly relates to the temperature of the continuous flow heater detected by a temperature sensor 56 and preferably further temperature information which is recorded by temperature sensors at measuring points 58, 60 downstream or upstream from the continuous flow heater 38 in the direction of flow. A reed switch 62 is further provided in the rear assembly 14. The task of the reed switch 62 is to electrically detect a minimum filling level in the water container 18. For this purpose a float comprising a magnet is located vertically displaceably in the water container 18. When the water falls below a minimum filling volume in the water container 18, the magnetic float is located near to the reed switch 22 and makes this switch on, closing a circuit which transmits a signal to the electronic controller that the level is too low. If the level in the water container is lower than the minimum filling volume, the coffee machine cannot be operated. The continuous flow heater 38 can also have a sensor which prevents any running dry during the heating process.

The pipe 60 of the continuous flow heater 38 is flattened in the area in which the heating rods 42, 44 abut against the pipe 60. In this way, contact surfaces 88, 90 are preferably provided over the entire or almost the entire length of the continuous flow heater 38, a radial position of the contact surfaces 88, 90 being shown by the broken lines in FIG. 1 as an example. If the heating rods are correspondingly designed likewise with a flat side, good contact and consequently good heat transfer can be accomplished between the heating rods 42, 44 and the pipe 60. The arrangement of pipe 60 and heating rods 42, 44 is held together by a sleeve 64 which can be made of heat-resistant plastic or metal. The temperature sensor 56 is located in the area of this sleeve 64. Tubular connection supports 66, 68 are attached to the ends of the pipe 60. In the present exemplary embodiment, these are inserted in the pipe 60 and fitted with a circumferential seal 70, 72, for example, an O-ring. Securing means 74, 76, 78, 80 are moulded onto the tubular connection supports 66, 68 made of heat-resistant plastic, only some of the securing means being identified with reference numerals as an example here. These securing means 74, 76, 78, 80 are used to secure and centre the continuous flow heater 38 in the housing and also provide receiving elements for additional components, for example, a receiving element for the reed switch 62 in the securing means 78. A receiving element 86 for a safety valve 82 is furthermore built into the tubular connection support 68. The continuous flow heater 38 can thus be mounted as a complete unit with the tubular connection supports 66, 68 and the hoses placed thereon and can easily be inserted in the housing as a result of the centring properties.

The features of the invention disclosed in the preceding description, in the drawings and in the claims can be important for carrying out the invention both individually and also in any combination.

Reference list:

10 Coffee machine

12 Front portion

14 Rear assembly

16 Outlet

18 Water container

20 Brewing chamber

22 Drawer

24 Coffee pad retainer

26 Lever

28 Retainer cover

30 Brewing chamber upper portion

32 Pump

34 Hose

36 Hose

38 Continuous flow heater

40 Pipe

42 Heating rod

44 Heating rod

46 Electrical connection

48 Electrical connection

50 Keypad

52 Printed circuit board

54 Cable run

56 Temperature sensor

58 Measurement point

60 Measurement point

62 Reed switch

64 Sleeve

66 Tubular connection support

68 Tubular connection support

70 Seal

72 Seal

74 Securing means

76 Securing means

78 Securing means

80 Securing means

82 Safety valve

84 Receiving element

86 Receiving element

88 Contact surface

90 Contact surface

1-11. (canceled)

12. A coffee machine for preparing coffee using coffee pads, which comprises a continuous flow heater secured in a housing with a pipe for guiding water, which has a tubular connection support at least at one end, wherein the tubular connection support comprises securing means for securing the continuous flow heater in the housing.

13. The coffee machine according to claim 12, wherein the at least one tubular connection support is made from a high-temperature resistant plastic material.

14. The coffee machine according to claim 12, wherein the at least one tubular connection support comprises sealing means which abut against an inner wall of the pipe by which means the at least one tubular connection support is connected to the ends of the pipe in a sealed manner.

15. The coffee machine according to claim 14, wherein the sealing means is formed by an O-ring seal inserted in an annular groove on the outer circumference of the tubular connection support.

16. The coffee machine according to claim 15, wherein a plurality of axially spaced O-ring seals are provided on the tubular connection supports.

17. The coffee machine according to claim 12, wherein the tubular connection support is inserted in a corresponding end of the pipe.

18. The coffee machine according to claim 12, wherein the securing means has receiving elements for integrating additional components of the coffee machine.

19. The coffee machine according to claim 18, further comprising a safety valve as an additional component.

20. The coffee machine according to claim 18, further comprising a temperature sensor as an additional component.

21. The coffee machine according to claim 18, further comprising a reed switch as a water level sensor as an additional component.

22. The coffee machine according to claim 12, further comprising a heating rod thermally connected to the pipe of the continuous flow heater by means of at least one flat contact surface.

23. The coffee machine according to claim 22, further comprising at least two heating rods thermally connected to the pipe of the continuous flow heater by means of at least one flat contact surface.

24. The coffee machine according to claim 22, wherein the arrangement of pipe and heating rods is held together by a sleeve.

25. The coffee machine according to claim 24, further comprising a temperature sensor disposed on the sleeve.
